(19) United States
(12) Patent Application Publication
(10) Pub. No.: US 2019/0369203 A1
(43) Pub. Date: Dec. 5, 2019

(54) BICYCLE TRACKING FOR BIKE-SHARING SYSTEM

(71) Applicant: Ford Global Technologies, LLC, Dearborn, MI (US)

(72) Inventors: Arthur Erik ZYSK, JR., Dearborn, MI (US); Zachary David NELSON, Dearborn, MI (US); Jayanthi RAO, Dearborn, MI (US); John Randolf VINCENT, Dearborn, MI (US); Mark Allan LIPPMAN, Dearborn, MI (US)

(21) Appl. No.: 16/468,771

(22) PCT Filed: Dec. 13, 2016
(86) PCT No.: PCT/US2016/066358

§ 371 Date: Jun. 12, 2019

(51) Int. Cl. G01S 5/02; G01S 5/14

(52) U.S. Cl. CPC G01S 5/0294; B62H 3/00; G01S 5/0231; G01S 5/14

(57) ABSTRACT

A bicycle-sharing system includes bicycles having beacons mounted thereto. Sensors are distributed throughout an urban environment and detect the beacons. Stations report check-in and check-out of the bicycles. Using reported detections of the bicycles and the check-in and check-out locations, a trajectory of the bicycle is determined. Where multiple sensors detect the beacon at a time, triangulation may be performed to more accurately determine the bicycle location. Trajectories of bicycles may be used for planning purposes or to track stolen or mislaid bicycles.

### BACKGROUND

### Field of the Invention

This invention relates to systems and methods for implementing a bicycle-sharing system.

### Background of the Invention

Today, many bicycle-sharing programs are designed such that users take out and return bicycles from docking station hubs placed throughout a city or region. Although the bike-share operator (typically a company responsible for maintaining the service, e.g. MOTIVATE) can easily identify the hubs at which a given bike begins and ends its journey, this information does not detail the path between hubs that the bicycle may have traveled. Unfortunately, the use of GPS modules to track bicycles often proves inaccurate in cities with tall buildings due to the “urban canyon” effect.

The system and method disclosed herein provide an improved approach for tracking shared bicycles.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a schematic diagram illustrating a bicycle tracking system in accordance with an embodiment of the present invention;

FIG. 2 is a process flow diagram of a method for tracking shared bicycles in accordance with an embodiment of the present invention;

FIGS. 3A to 3C are schematic diagrams illustrating the tracking of a shared bicycle in accordance with an embodiment of the present invention; and

FIG. 4 is a schematic block diagram of a computer system capable of implementing the methods disclosed herein.

### DETAILED DESCRIPTION

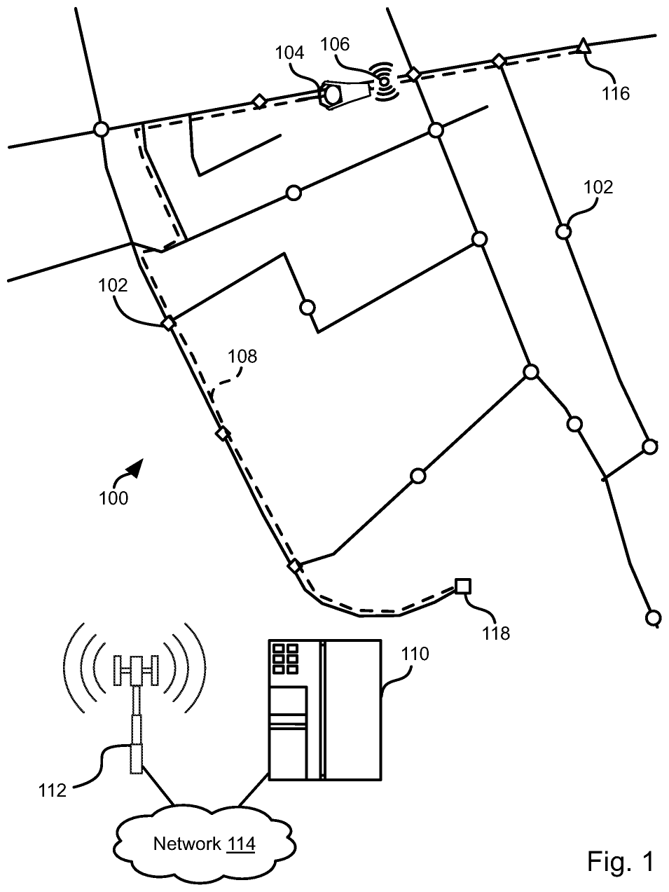

Referring to FIG. 1, a bicycle-sharing system 100 may include a plurality of sensors 102 shown by circles and diamonds. The sensors 102 are distributed throughout an urban environment along various streets. A shared bicycle 104 may carry a beacon 106 that is perceptible by the sensors. The shared bicycle 104 may follow a trajectory 108 that passes within range of some sensors 102, shown as diamonds, but not passing within range of some other sensors 102, shown as circles.

The shared bicycle 104 may lack a GPS receiver and may further lack the ability to communicate information, other than to broadcast a fixed signal using the beacon 106. In other instances, the shared bicycle may have a GPS receiver. However, the system and method disclosed herein are particularly useful where a GPS receiver does not function properly due to the urban canyon effect or other limitations.

In some embodiments, the shared bicycle 104 has a beacon 106 mounted thereto that is embodied as a BLUETOOTH low energy (BLE) beacon. Accordingly, the sensors 102 may be embodied as BLE receivers. The sensors 102 may be in data communication with a server system 110 through wired connections or by communication with one or more cellular communication towers 112. The cellular communication towers 112 may be in data communication with the server system 110 by means of a network 114. The network 114 may include a local area network (LAN), wide area network (WAN), the Internet, or any other wired or wireless connection.

A BLE sensor 102 may detect both the presence of a BLE beacon 106 and measure strength of a signal from the BLE beacon. The signal may include an identifier of the beacon 106. A bike-sharing program may include many bicycles each having a BLE beacon 106 mounted thereto that broadcasts a signal communicating unique identifier. The BLE sensors 102 may therefore transmit to the server system 110 records for each detection of a BLE beacon 106, the record including a time of detection, the identifier of the detected BLE beacon 106, and the signal strength of the signal detected from the BLE beacon 106.

The server system 110 interprets these records in order to estimate the trajectory 108 of the shared bicycle 104. The starting point of the trajectory 108 may be set by the server system 110 to be a check-out station 116, from which the shared bicycle 104 was taken. Likewise, a check-in station 118 to which the shared bicycle 104 is checked in may be set by the server system 110 to be the location of the check-in station. The check-in station 118 and check-out station 116 may both function as either a check-in or check-out station as known in the art of bicycle-sharing programs. The check-out station and check-in station 116, 118 may include computer devices that are programmed to report identifiers of bicycles 104 that are checked into and checked out of the station 116, 118 to the server system 110. The reports of identifiers may include an identifier of the station 116, 118 making the report and the server system 110 may have access to a database storing locations for each station identifier.

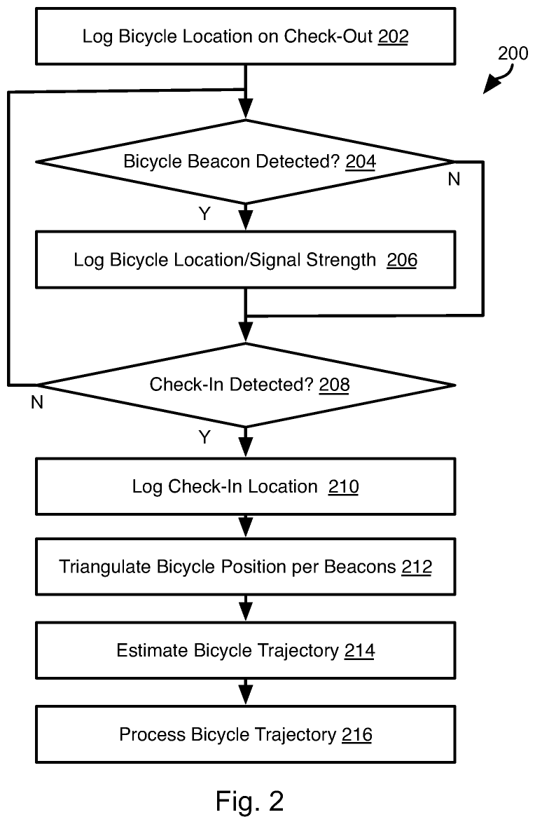

Referring to FIG. 2, the server system 110 may execute the illustrated method 200. The method 200 may include logging 202 the location of a shared bicycle 104 upon check out from a check-out station 116. Step 202 may include receiving a report from the check-out station 116 that includes an identifier of the check-out station 116 and an identifier of the shared bicycle that has been checked out. The identifier of the check-out station may include the location of the check-out station or may be resolved to a location using a database mapping the identifier of the check-out stations to locations thereof.

The method 200 may then include receiving zero or more reports from sensors 102 reporting sensing of the beacon 106 mounted to the shared bicycle. If a sensor 102 is found 204 to detect the beacon of the shared bicycle, this report may be logged 206 for the shared bicycle 104. As noted above, the sensor 102 may report the identifier of the beacon 106, an identifier or location of the sensor 102, and the strength of the signal received from the beacon 106. The server system 110 may resolve the location of the sensor 102 according to a database mapping sensor identifiers to locations. Steps 204 and 206 may be repeated throughout a ride. There may also be cases where no sensors 102 detect a beacon 106 during a trip.

The method 200 may further include detecting 208 check in of the shared bicycle 104. Such as by receiving a report from the station 118 to which the shared bicycle was checked in. As before, this report may include an identifier of the shared bicycle 104 that was checked in and an identifier or location of the check-in station 118, or an identifier that the server system 110 resolves to a location. The method 200 includes logging 210 the location of the check-in station 118.

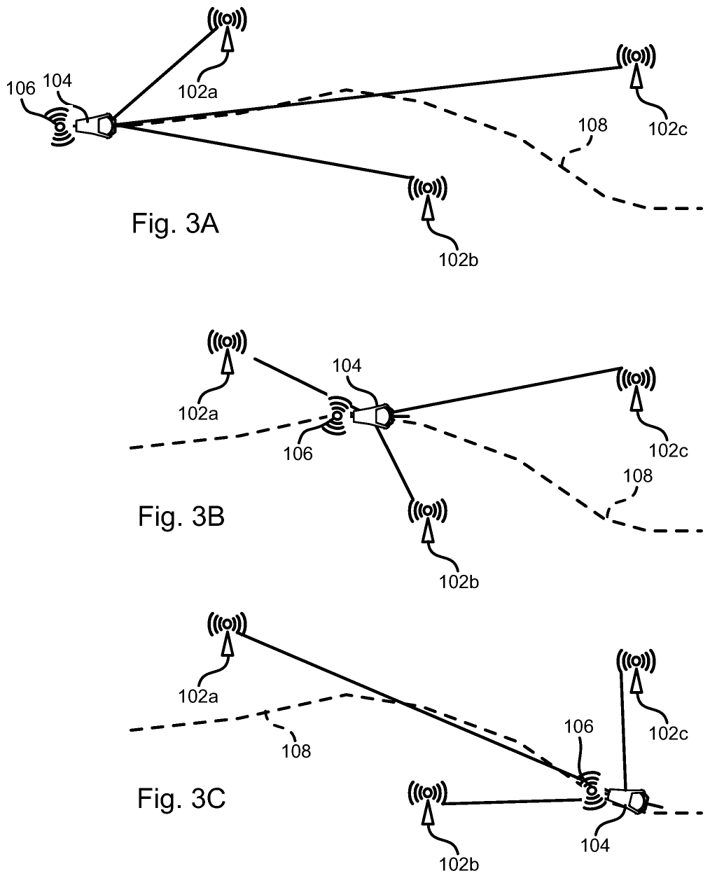

The method 200 may include triangulating 212 a position of the shared bicycle 104. For example, FIGS. 3A to 3C each illustrate a position of the shared bicycle 104 at different points along the trajectory 108. In the illustrated embodiment, a plurality of sensors 102a-102c detect the beacon 106 of the shared bicycle 104 at each point in time. However, at each point in time the distances from the shared bicycle 104 to the sensors 102a-102c are different. As noted above, when each sensor 102a-102c reports detection of the beacon 106 of the shared bicycle 104, each sensor 102a-102c may also report a signal strength from the beacon 106. Accordingly, a distance from each sensor 102a-102c to the beacon 106 may be estimated. The location of the beacon 106 at a point in time may therefore be determined using triangulation based on the known locations of the sensors 102a-102c and the distances to the beacon 106 from the sensors 102a-102c. The method by which triangulation is performed may include any approach for using triangulation to determine a location as known in the art.

Using the check-out location of step 202, the check-in location of step 210, the locations of sensors 102 that detected the beacon 106, and any locations determined by triangulation at step 212, hereinafter the “known locations,” a trajectory of the bicycle may be estimated 214. Note that triangulation may not always be possible such that only the location of a sensor 102 is used in some cases rather than a triangulated position of the beacon 106. For example, a trajectory may be determined that passes through the known locations. The estimated trajectory may also be a trajectory that does not pass within a detection range of sensors 102 that did not detect the beacon of the shared bicycle between the time of check out and the time of check in.

Subject to the constraints of passing through the known location and not passing within range of non-detecting sensors 102, the trajectory may be estimated to be a shortest route that meets these constraints. The trajectory may be estimated as a route that does not pass through roads that are impassible for bikes, e.g. freeways or heavy traffic areas. The selection of the estimated trajectory may also be biased towards roads having bike lanes or that are otherwise flagged as being suitable for bike traffic.

The method 200 may then include processing 216 the bicycle trajectory in some way. Knowing the trajectory of shared bicycles may be used for various purposes. For example, a city planner may determine preferred routes of cyclists in order to determine where to put a bike lane or where to place bicycle-sharing stations. Processing 216 of the trajectory may also be performed in order to determine the location of a stolen bicycle or a bicycle that was otherwise not properly returned to a bicycle-sharing station.

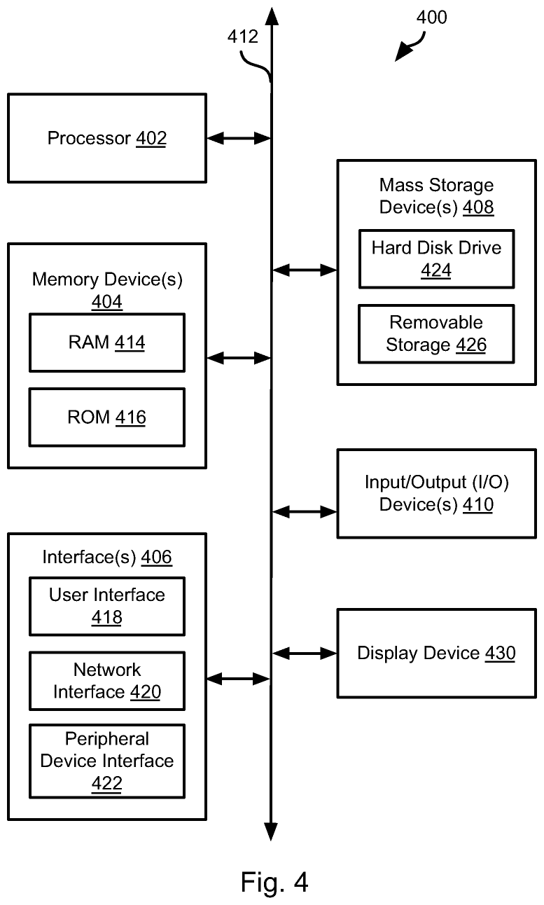

FIG. 4 is a block diagram illustrating an example computing device 400. Computing device 400 may be used to perform various procedures, such as those discussed herein. The sensors 102, beacons 106, server system 110, and stations 116, 118 may have some or all of the attributes of the computing device 400.

Computing device 400 includes one or more processor(s) 402, one or more memory device(s) 404, one or more interface(s) 406, one or more mass storage device(s) 408, one or more Input/Output (I/O) device(s) 410, and a display device 430 all of which are coupled to a bus 412. Processor(s) 402 include one or more processors or controllers that execute instructions stored in memory device(s) 404 and/or mass storage device(s) 408. Processor(s) 402 may also include various types of computer-readable media, such as cache memory.

Memory device(s) 404 include various computer-readable media, such as volatile memory (e.g., random access memory (RAM) 414) and/or nonvolatile memory (e.g., read-only memory (ROM) 416). Memory device(s) 404 may also include rewritable ROM, such as Flash memory.

Mass storage device(s) 408 include various computer readable media, such as magnetic tapes, magnetic disks, optical disks, solid-state memory (e.g., Flash memory), and so forth. As shown in FIG. 4, a particular mass storage device is a hard disk drive 424. Various drives may also be included in mass storage device(s) 408 to enable reading from and/or writing to the various computer readable media. Mass storage device(s) 408 include removable media 426 and/or non-removable media.

I/O device(s) 410 include various devices that allow data and/or other information to be input to or retrieved from computing device 400. Example I/O device(s) 410 include cursor control devices, keyboards, keypads, microphones, monitors or other display devices, speakers, printers, network interface cards, modems, lenses, CCDs or other image capture devices, and the like.

Display device 430 includes any type of device capable of displaying information to one or more users of computing device 400. Examples of display device 430 include a monitor, display terminal, video projection device, and the like.

Interface(s) 406 include various interfaces that allow computing device 400 to interact with other systems, devices, or computing environments. Example interface(s) 406 include any number of different network interfaces 420, such as interfaces to local area networks (LANs), wide area networks (WANs), wireless networks, and the Internet. Other interface(s) include user interface 418 and peripheral device interface 422. The interface(s) 406 may also include one or more peripheral interfaces such as interfaces for printers, pointing devices (mice, track pad, etc.), keyboards, and the like.

Bus 412 allows processor(s) 402, memory device(s) 404, interface(s) 406, mass storage device(s) 408, I/O device(s) 410, and display device 430 to communicate with one another, as well as other devices or components coupled to bus 412. Bus 412 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 400, and are executed by processor(s) 402. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

In the above disclosure, reference has been made to the accompanying drawings, which form a part hereof, and in which is shown by way of illustration specific implementations in which the disclosure may be practiced. It is understood that other implementations may be utilized and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Implementations of the systems, devices, and methods disclosed herein may comprise or utilize a special purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links, which can be used to carry desired program code means in the form of computer-executable instructions or data structures and which can be accessed by a general purpose or special purpose computer. Combinations of the above should also be included within the scope of computer-readable media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, an in-dash vehicle computer, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the description and claims to refer to particular system components. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors, and may include hardware logic/electrical circuitry controlled by the computer code. These example devices are provided herein purposes of illustration, and are not intended to be limiting. Embodiments of the present disclosure may be implemented in further types of devices, as would be known to persons skilled in the relevant art(s).

At least some embodiments of the disclosure have been directed to computer program products comprising such logic (e.g., in the form of software) stored on any computer useable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments, but should be defined only in accordance with the following claims and their equivalents. The foregoing description has been presented for the purposes of illustration and description. It is not intended to be exhaustive or to limit the disclosure to the precise form disclosed. Many modifications and variations are possible in light of the above teaching. Further, it should be noted that any or all of the aforementioned alternate implementations may be used in any combination desired to form additional hybrid implementations of the disclosure.

1. A method comprising, by a computer system:
receiving outputs from a plurality of sensors positioned throughout an urban environment;
identifying references to a beacon mounted to a shared bicycle in the outputs; and
determining a trajectory of the shared bicycle according to locations of the plurality of sensors.

2. The method of claim 1, wherein the beacon is a BLUETOOTH LOW ENERGY (BLE) beacon.

3. The method of claim 1, further comprising determining the trajectory of the shared bicycle by triangulating a position of the shared bicycle from the locations of the plurality of sensors.

4. The method of claim 1, further comprising determining the trajectory of the shared bicycle by triangulating a position of the shared bicycle from the locations of the plurality of sensors and signal strengths included in the outputs indicating strength of a signal from the beacon.

5. The method of claim 1, further comprising:
receiving a notification from a check-out station referencing the shared bicycle; and
setting an origin of the trajectory of the shared bicycle to be a location of the check-out station.

6. The method of claim 5, further comprising:
receiving a notification from a check-in station referencing the shared bicycle; and
setting an end of the trajectory of the shared bicycle to be a location of the check-in station.

7. The method of claim 1, further comprising determining the trajectory of the shared bicycle such that that the trajectory does not pass within range of one or more sensors that did not produce outputs referencing the beacon mounted to the shared bicycle.

8. The method of claim 1, further comprising determining the trajectory of the each bicycle according to the locations of the one or more sensors comprises determining the trajectory without receiving global positioning system (GPS) coordinates from any GPS receiver mounted to the each bicycle.

9. The method of claim 1, further comprising determining usage patterns of a plurality of bicycles including the shared bicycle according to trajectories of the plurality of bicycles.

10. The method of claim 1, further comprising locating the shared bicycle following theft according to the trajectory of the shared bicycle.

11. An apparatus comprising:
a plurality of bicycles, each having a beacon mounted thereto;
a plurality of sensors positioned throughout an urban environment;
a server system operably coupled to the plurality of sensors, the server system programmed to, for each bicycle of the plurality of bicycles:
receive outputs of one or more sensors of the plurality of sensors referencing the beacon mounted to the each bicycle; and
determine a trajectory of the each bicycle according to locations of the one or more sensors.

12. The apparatus of claim 11, wherein the beacon is a BLUETOOTH LOW ENERGY (BLE) beacon.

13. The apparatus of claim 11, wherein the server system is programmed to determine the trajectory of the each bicycle according to the locations of the one or more sensors by:
triangulating a position of the each bicycle from outputs of the one or more sensors and the locations of the one or more sensors.

14. The apparatus of claim 11, wherein the server system is programmed to determine the trajectory of the each bicycle according to the locations of the one or more sensors by:
triangulating a position of the each bicycle from outputs of the one or more sensors and the locations of the one or more sensors, the outputs of the one or more sensors including a signal strength of a signal from the beacon mounted to the each bicycle.

15. The apparatus of claim 11, wherein the server system is further programmed to:
receive, for each bicycle of the plurality of bicycles, a notification from a check-out station; and
set an origin of the trajectory of the each bicycle to be a location of the check-out station.

16. The apparatus of claim 15, wherein the server system is further programmed to:
receive, for each bicycle of the plurality of bicycles, a notification from a check-in station; and
set an end of the trajectory of the each bicycle to be a location of the check-in station.

17. The apparatus of claim 11, wherein the server system is further programmed to determine the trajectory of the each bicycle according to locations of the one or more sensors by determining a trajectory that does not pass within range of a portion of the plurality of sensors that did not produce outputs referencing the beacon mounted to the each bicycle.

18. The apparatus of claim 1, wherein the server system is programmed determine the trajectory of the each bicycle according to the locations of the one or more sensors comprises determining the trajectory without receiving global positioning system (GPS) coordinates from any GPS receiver mounted to the each bicycle.

19. The apparatus of claim 1, wherein the server system is further programmed to determine usage patterns of the plurality of bicycles according to the trajectories of the plurality of bicycles.

20. The apparatus of claim 1, wherein the server system is further programmed to locate a stolen bicycle the plurality of bicycles according to the trajectory corresponding to the stolen bicycle.
